(19) United States
(12) Patent Application Publication
(10) Pub. No.: US 2025/0024317 A1
(43) Pub. Date: Jan. 16, 2025

(54) METHOD, DEVICE AND COMPUTER-READABLE STORAGE MEDIUM FOR WIRELESS COMMUNICATION

(71) Applicant: ZTE CORPORATION, Shenzhen (CN)

(72) Inventors: Xiubin SHA, Beijing (CN); Bo DAI, Beijing (CN); Yuan GAO, Beijing (CN); He HUANG, Beijing (CN); Eswar Kalyan VUTUKURI, Beijing (CN)

(73) Assignee: ZTE CORPORATION, Shenzhen (CN)

(21) Appl. No.: 18/903,779

(22) Filed: Oct. 1, 2024

Related U.S. Application Data
(63) Continuation of application No. PCT/CN2022/093400, filed on May 17, 2022.

(51) Int. Cl. H04W 28/02; H04L 47/34

(52) U.S. Cl. CPC H04W 28/0268; H04L 47/34

(57) ABSTRACT

Method, device and computer-readable storage medium for wireless communication are provided. A method includes: receiving, by a wireless communication node from a higher layer, Protocol Data Units, PDUs including identification information; and identifying, by the wireless communication node, PDU sets for the PDUs and a PDU set time sequence of the PDU sets; wherein the PDUs are scheduled for transmission over a Uu interface according to at least one of: the PDU sets or the PDU set time sequence; wherein the higher layer comprises at least one of: a General Packet Radio Service Tunneling Protocol User Plane, GTP-U, a Next Generation user plane interface, NG-U, an Xn User plane, Xn-U interface, user data from Non-access stratum, NAS, or user data of QoS flow.

### CROSS REFERENCE TO RELATED APPLICATIONS

The present disclosure is a continuation of International Patent Application No. PCT/CN2022/093400, filed on May 17, 2022, which is incorporated by reference in its entirety into the present application.

### TECHNICAL FIELD

This document is directed generally to wireless communications, in particular to 5th generation (5G) wireless communication.

### BACKGROUND

XR (Extended Reality) services are usually video streaming, which is expressed by multiple application data units. Each application data unit is composed of multiple application frames, e.g., I-frames, P-frames, B-frames. These application frames may depend on each other and have a certain order for transmitting, decoding, or presenting.

### SUMMARY

The present disclosure relates to methods, devices, and computer program products for identifying PDU sets and a PDU set time sequence in a wireless communication.

One aspect of the present disclosure relates to a wireless communication method. In some embodiments, the wireless communication method includes: receiving, by a wireless communication node from a higher layer, Protocol Data Units, PDUs including identification information; and identifying, by the wireless communication node, PDU sets for the PDUs and/or a PDU set time sequence of the PDU sets; wherein the PDUs are scheduled for transmission over a Uu interface according to at least one of: the PDU sets or the PDU set time sequence; wherein the higher layer comprises at least one of: a General Packet Radio Service Tunneling Protocol User Plane, GTP-U, a Next Generation user plane interface, NG-U, an Xn User plane, Xn-U interface, user data from Non-access stratum, NAS, or user data of QoS flow.

Another aspect of the present disclosure relates to a wireless communication method. In some embodiments, the wireless communication method includes: transmitting, by a wireless communication node to a core network, CN, or a wireless communication terminal, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the core network or the wireless communication terminal to determine, select, accept, reject, or recommend QoS information based on the one or more sets of suggested QoS assistance information.

Another aspect of the present disclosure relates to a wireless communication method. In some embodiments, the wireless communication method includes: receiving, by a wireless communication node from a wireless communication terminal, a buffer size indication.

Another aspect of the present disclosure relates to a wireless communication method. In some embodiments, the wireless communication method includes: transmitting, by a wireless communication node to a wireless communication terminal, Discontinuous Reception in RRC_Connected state, C-DRX, configurations; and performing, by the wireless communication node with the wireless communication terminal, a communication with multiple C-DRX patterns per cell group, per data radio bearer, DRB, or per logical channel according to the C-DRX configurations.

Another aspect of the present disclosure relates to a wireless communication method. In some embodiments, the wireless communication method includes: receiving, by a wireless communication node from a wireless communication terminal, a Buffer Status report, BSR for an uplink, UL, response protocol data unit, PDU, corresponding to a downlink, DL, PDU.

Another aspect of the present disclosure relates to a wireless communication method. In some embodiments, the wireless communication method includes: receiving, by a wireless communication node from a first wireless communication terminal, a first protocol data unit, PDU, corresponding to a second PDU of a second wireless communication terminal.

Another aspect of the present disclosure relates to a wireless communication method. In some embodiments, the wireless communication method includes: receiving, by a node in a core network, CN, from a wireless communication node, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the core network to determine, select, accept, reject, or recommend QoS information based on the one or more sets of suggested QoS assistance information.

Another aspect of the present disclosure relates to a wireless communication method. In some embodiments, the wireless communication method includes: receiving, by a wireless communication terminal from a wireless communication node, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the wireless communication terminal to determine, select, accept, reject, or recommend QoS information based on the one or more sets of suggested QoS assistance information.

Another aspect of the present disclosure relates to a wireless communication method. In some embodiments, the wireless communication method includes: transmitting, by a wireless communication terminal to a wireless communication node, a buffer size indication.

Another aspect of the present disclosure relates to a wireless communication method. In some embodiments, the wireless communication method includes: receiving, by a wireless communication terminal from a wireless communication node, Discontinuous Reception in RRC_Connected state, C-DRX, configurations; and performing, by the wireless communication terminal with the wireless communication node, a communication with multiple C-DRX patterns per cell group, per data radio bearer, DRB, or per logical channel according to the C-DRX configurations.

Another aspect of the present disclosure relates to a wireless communication method. In some embodiments, the wireless communication method includes: transmitting, by a wireless communication terminal to a wireless communication node, a Buffer Status report, BSR for an uplink, UL, response protocol data unit, PDU, corresponding to a downlink, DL, PDU.

Another aspect of the present disclosure relates to a wireless communication method. In some embodiments, the wireless communication method includes: transmitting, by a first wireless communication terminal to a wireless communication node, a first protocol data unit, PDU, corresponding to a second PDU of a second wireless communication terminal.

Another aspect of the present disclosure relates to a wireless communication node. In some embodiments, the wireless communication node includes a communication unit and a processor. The processor is configured to: receive, from a higher layer, Protocol Data Units, PDUs including PDU set information; and identify PDU sets for the PDUs and/or a PDU set time sequence of the PDU sets; wherein the PDUs are scheduled for transmission over a Uu interface according to at least one of: the PDU sets or the PDU set time sequence; wherein the higher layer comprises at least one of: a General Packet Radio Service Tunneling Protocol User Plane, GTP-U, a Next Generation user plane interface, NG-U, an Xn User plane, Xn-U interface, user data from Non-access stratum, NAS, or user data of QoS flow.

Another aspect of the present disclosure relates to a wireless communication node. In some embodiments, the wireless communication node includes a communication unit and a processor. The processor is configured to: transmit, to a core network, CN, or a wireless communication terminal, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the core network or the wireless communication terminal to determine, select, accept, reject, or recommend QoS information based on the one or more sets of suggested QoS assistance information.

Another aspect of the present disclosure relates to a wireless communication node. In some embodiments, the wireless communication node includes a communication unit and a processor. The processor is configured to: receive, from a wireless communication terminal, a buffer size indication.

Another aspect of the present disclosure relates to a wireless communication node. In some embodiments, the wireless communication node includes a communication unit and a processor. The processor is configured to: transmit, to a wireless communication terminal, Discontinuous Reception in RRC_Connected state, C-DRX, configurations; and perform, with the wireless communication terminal, a communication with multiple C-DRX patterns per cell group, per data radio bearer, DRB, or per logical channel according to the C-DRX configurations.

Another aspect of the present disclosure relates to a wireless communication node. In some embodiments, the wireless communication node includes a communication unit and a processor. The processor is configured to: receive, from a wireless communication terminal, a Buffer Status report, BSR for an uplink, UL, response protocol data unit, PDU, corresponding to a downlink, DL, PDU.

Another aspect of the present disclosure relates to a wireless communication node. In some embodiments, the wireless communication node includes a communication unit and a processor. The processor is configured to: receive, from a first wireless communication terminal, a first protocol data unit, PDU, corresponding to a second PDU of a second wireless communication terminal.

Another aspect of the present disclosure relates to a wireless communication node. In some embodiments, the wireless communication node includes a communication unit and a processor. The processor is configured to: receive, from a wireless communication node, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the core network to determine, select, accept, reject, or recommend QoS information based on the one or more sets of suggested QoS assistance information.

Another aspect of the present disclosure relates to a communication node (e.g., a communication node in a core network). In some embodiments, the communication node includes a communication unit and a processor. The processor is configured to: receive, from a wireless communication node, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the core network to determine, select, accept, reject, or recommend QoS information based on the one or more sets of suggested QoS assistance information.

Another aspect of the present disclosure relates to a wireless communication terminal. In some embodiments, the wireless communication terminal includes a communication unit and a processor. The processor is configured to: receive, from a wireless communication node, a reflective quality of service, QoS, indication or an initiative QoS update request according to at least one of a network capability or a network preference to trigger a QoS parameters update; wherein the reflective QoS indication or the initiative QoS update request comprises one or more sets of suggested QoS assistance information to allow the wireless communication terminal to determine, select, accept, reject, or recommend QoS information based on the one or more sets of suggested QoS assistance information.

Another aspect of the present disclosure relates to a wireless communication terminal. In some embodiments, the wireless communication terminal includes a communication unit and a processor. The processor is configured to: transmit, to a wireless communication node, a buffer size indication.

Another aspect of the present disclosure relates to a wireless communication terminal. In some embodiments, the wireless communication terminal includes a communication unit and a processor. The processor is configured to: receive, from a wireless communication node, Discontinuous Reception in RRC_Connected state, C-DRX, configurations; and perform, with the wireless communication node, a communication with multiple C-DRX patterns per cell group, per data radio bearer, DRB, or per logical channel according to the C-DRX configurations.

Another aspect of the present disclosure relates to a wireless communication terminal. In some embodiments, the wireless communication terminal includes a communication unit and a processor. The processor is configured to: transmit, to a wireless communication node, a Buffer Status report, BSR for an uplink, UL, response protocol data unit, PDU, corresponding to a downlink, DL, PDU.

Another aspect of the present disclosure relates to a wireless communication terminal. In some embodiments, the wireless communication terminal includes a communication unit and a processor. The processor is configured to: transmit, to a wireless communication node, a first protocol data unit, PDU, corresponding to a second PDU of a second wireless communication terminal.

Various embodiments may In some embodiments implement the following features:

In some embodiments, the wireless communication node receives PDU set sequence numbers for the PDU sets, and the PDU sets are determined by the PDU set sequence numbers.

In some embodiments, the PDU set time sequence is indicated by the PDU set sequence numbers.

In some embodiments, the PDU sets are mapped to different Quality of Service, QoS, flows, and PDU set sequence numbers are coded across multiple QoS flows based on a decoding time sequence of the QoS flows.

In some embodiments, the wireless communication node receives at least one of a PDU set start indication or a PDU set end indication for each PDU set, and the PDU sets are determined by the at least one of the PDU set start indication or the PDU set end indication.

In some embodiments, the PDU set time sequence is determined by QoS flow identifiers, QFIs, sequence numbers for the PDUs in the PDU sets.

In some embodiments, the PDU sets are mapped to different QoS flows, and the QFIs sequence numbers are coded across multiple QoS flows based on the PDU set time sequence.

In some embodiments, the wireless communication node includes the PDUs corresponding to each PDU set in a Service Data Adaption Protocol, SDAP, PDU.

In some embodiments, the PDUs corresponding to each PDU set are sequentially included in the SDAP PDU based on PDU sequence numbers of the PDUs.

In some embodiments, the wireless communication node includes the PDUs corresponding to each PDU set in one or more SDAP PDUs, and the one or more SDAP PDUs are included in a Packet Data Convergence Protocol, PDCP, PDU.

In some embodiments, the PDUs corresponding to each PDU set are sequentially included in the PDCP PDU.

In some embodiments, the PDCP PDU comprises one or more Message Authentication Code-Integrity, MAC-I, for the one or more SDAP PDUs.

In some embodiments, the wireless communication node indicates information of the PDU sets in at least one of an SDAP PDU, a PDCP PDU, or a radio link control, RLC, PDU, and the information of the PDU sets is indicated by using at least one of a temporary header or reserved bits.

In some embodiments, information of the PDU sets comprises at least one of a PDU set sequence number or a PDU set indication.

In some embodiments, information of the PDU set indication comprises at least one of: an indication indicating that a corresponding PDU is in a PDU set having single PDU, an indication indicating a corresponding PDU is at a start position of a corresponding PDU set, an indication indicating a corresponding PDU is at an end position of a corresponding PDU set, or an indication indicating a corresponding PDU is at a middle position of a corresponding PDU set.

In some embodiments, the wireless communication node transmits SDAP PDUs, PDCP PDUs or RLC PDUs corresponding to the same PDU sets in one transport block, TB, in one TB group or in an identical time domain position.

In some embodiments, the wireless communication node includes a PDU set type indication or a PDU set dependency indication in at least one of an SDAP PDU, a PDCP PDU, or an RLC PDU, and the information of the PDU sets is indicated by using at least one of a temporary header or reserved bits.

In some embodiments, the PDU set type indication indicates a corresponding PDU set corresponds to a video compression type of a I-Frame, a B-Frame, or a P-Frame, or indicates a corresponding PDU set decoding time sequence or PDU set decoding dependency, such as primary frame, secondary frame, nth secondary frame, where n is an integer.

In some embodiments, the PDU set dependency indication indicates a corresponding PDU set is individual, depends on a PDU set immediately ahead, or depends on a PDU set immediately ahead and a PDU set immediately afterwards.

In some embodiments, the wireless communication node indicates a PDU set dependency relationship between PDUs by including sequence numbers, SNs, in at least one of PDCP PDUs or RLC PDUs.

In some embodiments, the SNs in the at least one of the PDCP PDUs or the RLC PDUs are encoded over multiple data radio bearers, DRBs.

In some embodiments, the wireless communication node indicates a PDU set dependency relationship of a PDU by including an SN of an associated PDU and an identifier, ID, of an associated DRB or an associated logical channel in at least one of a PDCP PDU or an RLC PDU.

In some embodiments, the wireless communication node indicates PDU set sequence numbers in at least one of PDCP PDUs or RLC PDUs, and the PDU set sequence numbers are encoded over multiple DRBs or multiple logical channels based on the PDU set sequence numbers in PDCP service data units, SDUs.

In some embodiments, the suggested QoS assistance information comprises at least one of the following parameter types: a suggested QoS parameter value, a suggested priority level of a QoS flow, a suggested mapping between an application data and a QoS flow, a suggested paging strategy, user equipment, UE, mobility information, artificial intelligence related information, machine learning related information, network usage awareness, network Computational capability, or UE positioning related information.

In some embodiments, the SNs in the at least one of the PDCP PDUs or the RLC PDUs are encoded over multiple data radio bearers, DRBs.

In some embodiments, the wireless communication node indicates a PDU set dependency relationship of a PDU by including an SN of an associated PDU and an identifier, ID, of an associated DRB or an associated logical channel in at least one of a PDCP PDU or an RLC PDU.

In some embodiments, the wireless communication node indicates PDU set sequence numbers in at least one of PDCP PDUs or RLC PDUs, and the PDU set sequence numbers are encoded over multiple DRBs or multiple logical channels based on the PDU set sequence numbers in PDCP service data units, SDUs.

In some embodiments, the suggested QoS assistance information transmitted to the CN comprises at least one of the following parameters:
a maximal aggregated bit rate per cell that the wireless communication node prefers or allows;
a maximal bit rate per QoS flow carried that the wireless communication node prefers or allows;
a maximal aggregated bit rate per Protocol Data Unit, PDU, session that the wireless communication node prefers or allows;
a downlink, DL, PDU transmission time offset used to indicate the CN to transmit PDUs of a QoS flow or a PDU session with a time delay offset or a time advance offset, wherein the DL PDU transmission time offset is relative to at least one of a current transmission start time, a current transmission end time, or a current transmission timing occasion;
a DL PDU arriving time used to indicate the CN to transmit PDUs of the QoS flow or PDU session to ensure that the PDUs arrive at the wireless communication node based on the DL PDU arriving time;
a maximal packet size that the wireless communication node prefers or supports;
an application coding data rate that the wireless communication node prefers;
a CN Packet Delay Budget, PDB, that the wireless communication node detects, being used for the wireless communication node to decide a DL data transmission occasion;
a CN Packet Delay Budget headroom, that the wireless communication node detects, being used for the wireless communication node to decide a DL data transmission occasion;
a bit error rate, BER, that the wireless communication node detects;
a Packet Error Rate, PER, that the wireless communication node detects;
a network node load information;
a network node self Computational capability headroom;
a Computational capability headroom request to core network or cloud native;
a Uu Time Synchronization Error Budget;
a Uu Packet Delay Budget;
a Uu Packet Delay Budget headroom;
a time duration that a service is preferred to be used, being used for the wireless communication node to decide the DL data transmission occasion; or
a start time that the service is preferred to be triggered, being used for the wireless communication node to decide the DL data transmission occasion.

In some embodiments, the suggested QoS assistance information transmitted to the wireless communication terminal comprises at least one of the following parameters:
a maximal aggregated bit rate per UE that the wireless communication node prefers or allows;
a maximal aggregated bit rate per DRB that the wireless communication node prefers or allows;
a maximal aggregated bit rate per logical channel that the wireless communication node prefers or allows;
a maximal aggregated bit rate per logical channel group that the wireless communication node prefers or allows;
an application coding data rate that the wireless communication node prefers;
an uplink, UL, PDU transmission time offset used to indicate the wireless communication terminal to transmit PDUs of the DRB or Logical channel with a time delay offset or a time advance offset, wherein the UL PDU transmission time offset is relative to at least one of a current transmission start time, a current transmission end time, or a current the transmission timing occasion;
a UL PDU transmitting time used to indicate the wireless communication terminal to transmit PDUs of the DRB or Logical channel to ensure that the PDUs are transmitted based on the indicated transmitting time;
a BER that the wireless communication node detects, being used for the wireless communication terminal to adjust at least one of a coding rate or a transmitting power;
a PER that the wireless communication node detects being used for the wireless communication terminal to adjust at least one of a coding rate or a transmitting power;
a network node load information;
a network node self Computational capability headroom;
a Computational capability headroom request to core network or cloud native;
a Uu Time Synchronization Error Budget;
a Uu Packet Delay Budget;
a Uu Packet Delay Budget headroom;
a time duration that a service is preferred to be used, being used for the wireless communication terminal to decide a UL data transmission occasion; or
a start time that the service is preferred to be triggered, being used for the wireless communication terminal to decide a UL service start time or the UL data transmission occasion.

In some embodiments, the buffer size indication comprises at least one of:
a specific Buffer Status reporting, BSR, format indicating that a buffer size is identical to a latest reported buffer size;
a specific BSR Medium Access Control, MAC header with a new logical channel, LC, identifier, ID, indicating that a buffer size is identical to a latest reported buffer size for a logical channel, a logical channel group, or a data radio bearer, DRB;
a specific BSR Medium Access Control, MAC header with a new logical channel, LC, identifier, ID, indicating that a buffer size is identical to a latest transport block size transmitted for a logical channel, a logical channel group, or a DRB; or
uplink control information, indicating that a buffer size is identical to a latest transport block size transmitted for a logical channel, a logical channel group, or a DRB.

In some embodiments, each C-DRX configuration comprises a C-DRX index or a C-DRX identity used to identify the C-DRX configuration.

In some embodiments, a C-DRX index or a C-DRX identity of each C-DRX configuration are indicated by an order of the C-DRX configuration in a sequence.

In some embodiments, the wireless communication node transmits a request to the wireless communication terminal with a C-DRX index or a C-DRX identity to modify, remove, activate, or deactivate one of the C-DRX configurations corresponding to the C-DRX index or the C-DRX identity.

In some embodiments, the BSR comprises at least one of:
a DL logical channel, LC, identifier, ID, or a DL LC priority related to the UL response PDU;
a DL PDU response indication related to the UL response PDU; or related DL PDU information that includes at least one of a PDU sequence number, SN, or PDU time domain information.

In some embodiments, the PDU time domain information comprises at least one of System Frame Number information, Slot information, or Symbol information.

In some embodiments, the first PDU comprises at least one of:
an identifier, ID, of the second wireless communication terminal;
information of the second PDU;
a quality of service, QoS, flow ID, a logical channel, LC, ID, or an LC priority related to the first PDU; or
a PDU response indication related to the first PDU.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of PDU sets according to some embodiments of the present disclosure.

FIG. 2A shows a schematic diagrams of time sequences of frames according to some embodiments of the present disclosure.

FIG. 2B shows a schematic diagram of different layers according to some embodiments of the present disclosure.

FIG. 3 shows a schematic diagram of PDU sets according to another embodiment of the present disclosure.

FIG. 4 shows a schematic diagram of PDU sets according to another embodiment of the present disclosure.

FIG. 5A shows a schematic diagram of PDU sets according to another embodiment of the present disclosure.

FIGS. 5B to 5D show schematic diagrams of PDUs of different layers according to embodiments of the present disclosure.

FIG. 6A shows a schematic diagram of PDU sets according to another embodiment of the present disclosure.

FIGS. 6B and 6C show schematic diagrams of PDCP PDUs according to embodiments of the present disclosure.

FIGS. 7A to 7H show schematic diagrams of PDUs according to embodiments of the present disclosure.

FIGS. 8A to 8C show schematic diagrams of PDUs according to embodiments of the present disclosure.

FIG. 8D shows a schematic diagram of PDU sets according to another embodiment of the present disclosure.

FIGS. 8E to 8H show schematic diagrams of PDUs according to embodiments of the present disclosure.

FIGS. 9A and 9B show schematic diagrams of communication methods according to embodiments of the present disclosure.

FIGS. 10A to 10D show schematic diagrams of PDUs or BSRs according to embodiments of the present disclosure.

FIG. 11 shows a schematic diagram of a wireless communication terminal according to some embodiments of the present disclosure.

FIG. 12 shows a schematic diagram of a wireless communication node according to some embodiments of the present disclosure.

### DETAILED DESCRIPTION

In some embodiments, as illustrated in FIG. 1, one application frame (e.g., Application Data Unit (ADU)) may include multiple IP (Internet Protocol) packets which can be expressed in a PDU (protocol data unit) Set in a QoS (quality of service) flow. For example, a sequence of packets may include all the necessary information to reconstruct a video frame (e.g., equivalent to a “media unit” or a “slice”), such as video, audio, frame, tile, and/or haptic information. The packets can be packets of, for example, GTP-U (GPRS (General Packet Radio Service) Tunneling Protocol User Plane), NG (Next Generation) user plane interface (NG-U), Xn User plane (Xn-U) interface, or user data from NAS (Non-access stratum).

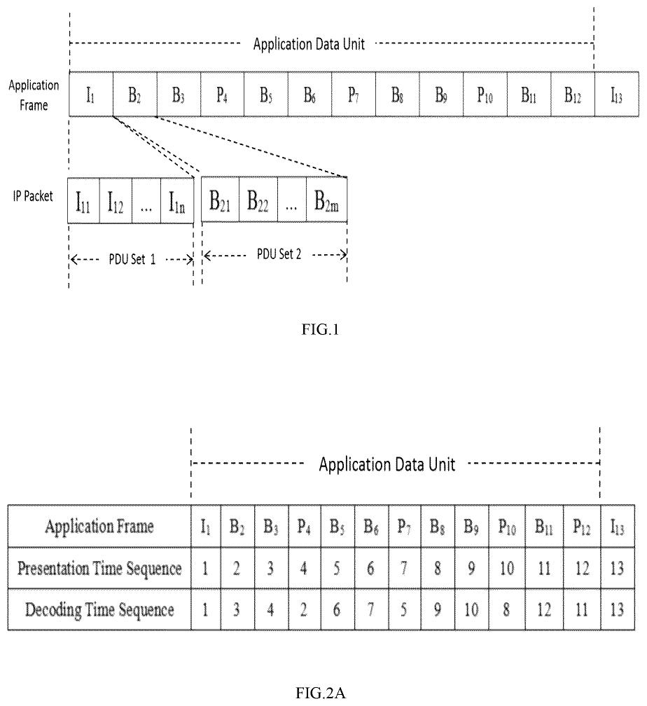

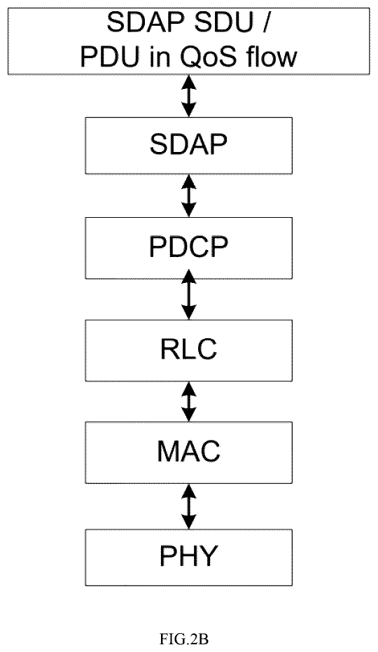

Since different application frames have different (de-) coding schemes, the QoS priority or importance level of the frame are different. For example, FIG. 2A shows the Decoding Time Sequence and Presentation Time Sequence for the ADU in FIG. 1.

In some embodiments, an I-frame is a keyframe, which stores/transmits all of the data needed to display that frame. In some embodiments, I-frames are interspersed with P-frames and B-frames in a compressed video. The more I-frames that are contained, the better quality the video could be. However, I-frames need many bits and need more space in the storage medium and consumes more radio resources for delivery.

In some embodiments, a P-frame is a delta frame, which contains the data that has changed from the preceding I-frame (such as color or content changes). Thus, the P-frame depends on the preceding I-frame to fill in relevant data.

In some embodiments, a B-frame is also a delta frame, which contains the data that has changed from the preceding frame and are different from the data in the very next frame. Thus, the B-frame depends on the frames preceding and following it to fill in relevant data.

Different application frames may have different QoS priorities or importance levels for the ADU decoding. E.g., in one application data unit, the higher the QoS priority or importance level of an application frame is, the smaller the Decoding Time Sequence number is.

In some embodiments, the QoS priority or importance level is indicated by the priority in QoS flow. Since there is only one priority level per QoS flow, application frames with different priorities may be mapped to different QoS flows. However, there is no PDU sequence dependency information between PDUs in different QoS flow. Thus, it is still unclear how to express the PDU Decoding Time Sequence in one application data unit.

Besides, after all the PDUs in one PDU set are received, the decoding side can decode the application frame. Afterwards, the PDU transmission is scheduled in RLC (radio link control) and/or MAC (Medium Access Control) layer based on the User Plane Protocol Stack as shown in FIG. 2B, either the PDUs corresponding to one PDU Set are included in one SDAP (Service Data Adaption Protocol) PDU and/or PDCP (Packet Data Convergence Protocol) PDU, or the transmission entity in RLC and/or MAC layer is aware of the PDU Set (e.g., be aware that the PDUs belong to the same PDU set) for radio resource scheduling and guarantee that all the PDUs in one PDU set can arrive the reception side simultaneously.

In some embodiments, a method of service characteristics indication in NG interface, PDCP entity, RLC entity and MAC entity is provided.

In some embodiments, a gNB may receive PDUs including identification information from a higher layer; wherein the higher layer comprises at least one of: a General Packet Radio Service Tunneling Protocol User Plane, GTP-U, a Next Generation user plane interface, NG-U, an Xn User plane, Xn-U interface, user data from Non-access stratum, NAS, or user data of QoS flow. The gNB may identify PDU sets for the PDUs and a PDU set time sequence of the PDU sets. E.g., the gNB may identify at least one of the PDU sets or the PDU set time sequence according to the identification information. Subsequently, the gNB may schedule the PDUs for transmission over a Uu interface according to at least one of PDU sets or the PDU set time sequence. The identification information includes at least one of PDU set sequence numbers and/or PDU set information. The PDU set information comprises at least one of a PDU set start indication and/or the PDU set end indication. In some embodiments, the Uu interface is an interface between the gNB and the UE. Details of the present disclosure are provided in the embodiments below, and the present disclosure is not limited thereto.

### Embodiment 1 (Mapping Between PDU Set and QoS Flow)

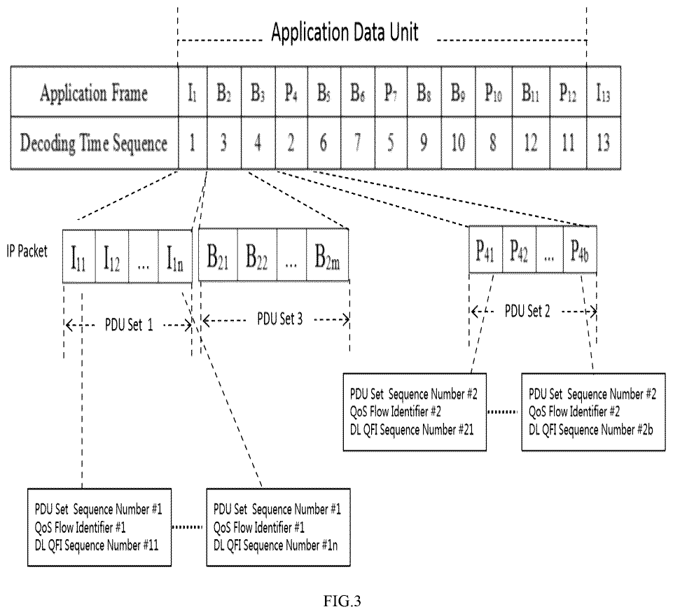

FIG. 3 shows a mapping between a GTP-U, NG-U, Xn-U, or NAS-U (Non-Access-Stratum User plain data) PDU set and QoS flows, in which a PDU set time sequence is indicated by PDU set sequence numbers.

In some embodiments, the PDU set is identified by the PDU set sequence numbers, and the PDU set time sequence is indicated by the PDU set sequence numbers. The PDU set sequence numbers are encoded/numbered across multiple QoS flows per PDU session or per traffic flow used to indicate the application frame sequence and/or application data unit sequence.

In some embodiments, the PDU set time sequence can be the PDU set decoding time sequence (e.g. only when the current PDU set is decoded successfully, the next PDU set can be decoded), or the PDU set presentation time sequence (e.g. for video streaming, the picture frame is presented one by one according to the presentation time sequence).

Since the PDU set is decoded based on the decoding time sequence in the receiving node, once a PDU set is not transmitted successfully, the next PDU set cannot be decoded successfully. It is preferred that the PDU set is delivered based on the decoding time sequence.

In FIG. 3, an example is used to show that the PDU set time sequence is indicated by the PDU set sequence numbers.

One application frame includes multiple IP packets (e.g., PDUs), which construct a PDU set.

Since the PDU set decoding is based on the decoding time sequence, different PDU sets have different priorities or importance levels. Accordingly, different PDU sets are mapped to different QoS flows, and the PDU set sequence numbers are coded/numbered across multiple QoS flows based on the decoding time sequence. The QFI (QOS flow identifiers) sequence numbers are encoded/numbered per QoS flow.

For example, in the embodiment corresponding to FIG. 3, the receiving side sequentially decodes the I1 frame, the P4 frame, the B2 frame, and so on, based on the decoding time sequence.

The I1 frame includes I11, I12, . . . , Iln packets (PDUs). The packets correspond to PDU set 1, are mapped to QoS Flow Identifier #1, and have the PDU Set Sequence Number 1.

The P4 frame includes P41, P42, . . . , P4b packets (PDUs). The packets correspond to PDU set 2, are mapped to QoS Flow Identifier #2 and have the PDU Set Sequence Number 2.

The B2 frame includes B21, B22, . . . , B2m packets (PDU). The packets correspond to PDU set 3, are mapped to QoS Flow Identifier #3 and have the PDU Set Sequence Number 3.

The rest can be deduced by analogy.

Since the DL (downlink) QFI sequence numbers are encoded/numbered per QoS flow, the DL QFI sequence numbers can be the same or different for the PDUs in different QoS flows.

In some embodiments, digital numbers are merely used to indicate the sequence numbers.

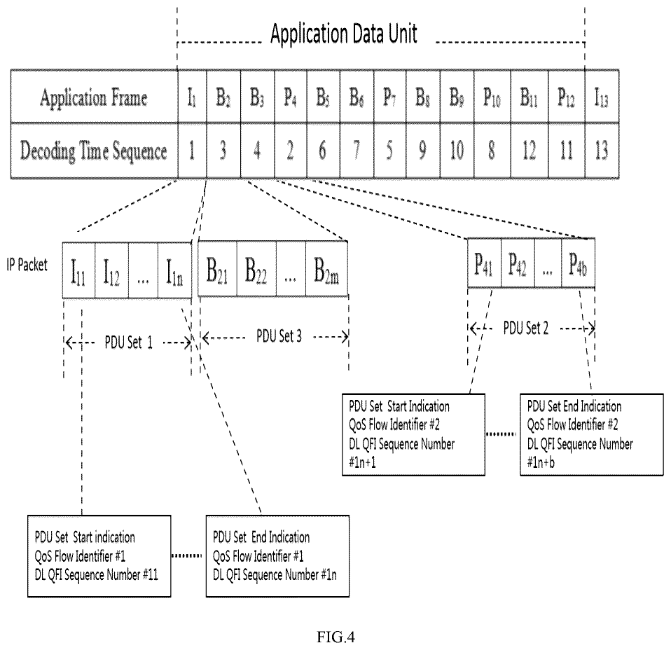

FIG. 4 shows a mapping between a GTP-U, NG-U, Xn-U, or NAS-U PDU set and QoS flows, in which a PDU set time sequence is indicated by DL QFI sequence numbers.

In some embodiments, the PDU set is identified by PDU set information including a PDU set start indication and/or a PDU set end indication and/or total PDUs number of a PDU set. The PDU set time sequence is indicated by DL QFI sequence numbers, which are encoded/numbered across multiple QoS flows per PDU session or per traffic flow used to indicate the application frame sequence and/or application data unit sequence.

In some embodiments, the PDU set time sequence can be the PDU set decoding time sequence (e.g. only when the current PDU set is decoded successfully, the next PDU set can be decoded), or the PDU set presentation time sequence (e.g. for video streaming, the picture frame is presented one by one according to the presentation time sequence).

In FIG. 4, an example is used to show that the PDU set time sequence is indicated by DL QFI sequence numbers.

One application frame includes multiple IP packets, which construct a PDU set, and is identified by a PDU set start indication and a PDU set start indication. E.g., in the PDU set 1: the packet I11 corresponds to the PDU set start indication, and the packet IIn corresponds to the PDU set end indication.

Since the PDU set decoding is based on the decoding time sequence, different PDU sets have different priorities or importance levels. Thus, different PDU sets are mapped to different QoS flows. When PDU set information (e.g., the PDU set start indication or the PDU set end indication) is included, the DL QFI sequence numbers are coded/numbered across multiple QoS flows based on the decoding time sequence.

For example, in the embodiment corresponding to FIG. 4, the receiving side sequentially decodes the I1 frame, the P4 frame, the B2 frame, and so on, based on the decoding time sequence.

The I1 frame includes I11, I12, . . . , Iln packets (PDUs). The packets correspond to PDU set 1 and are mapped to QoS Flow Identifier #1. The DL QFI sequence number of the packets I11, I12, . . . , Iln are encoded/numbered as 11, 12, . . . , In.

The P4 frame includes P41, P42, . . . , P4b packets (PDUs). The packets correspond to PDU set 2 and are mapped to QoS Flow Identifier #2. The DL QFI sequence numbers of the packets P41, P42, . . . , P4b are encoded/numbered as 1n+1, 1n+2, . . . , 1n+b.

The B2 frame includes B21, B22, . . . , B2m packets (PDU). The packets correspond to PDU set 3 and are mapped to QoS Flow Identifier #3. The DL QFI sequence number of the packets B21, B22, . . . , B2m are encoded/numbered as 1n+b+1, 1n+b+2, . . . , 1n+b+m).

The rest can be deduced by analogy.

In some embodiments, digital numbers are merely used to indicate the sequence numbers.

When PDU set information is included in a PDU session information format, the DL QFI sequence numbers are encoded/numbered across multiple QoS flows based on the PDU set decoding time sequence to indicate the decoding time sequence. When PDU set information is not included in the PDU session information format, the DL QFI sequence numbers are encoded per QoS flow.

### Embodiment 2 (PDUs in One PDU Set are Mapped to One SDAP PDU)

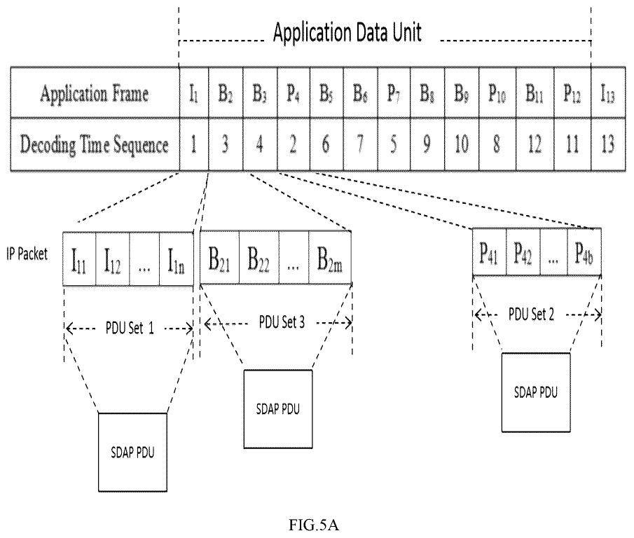

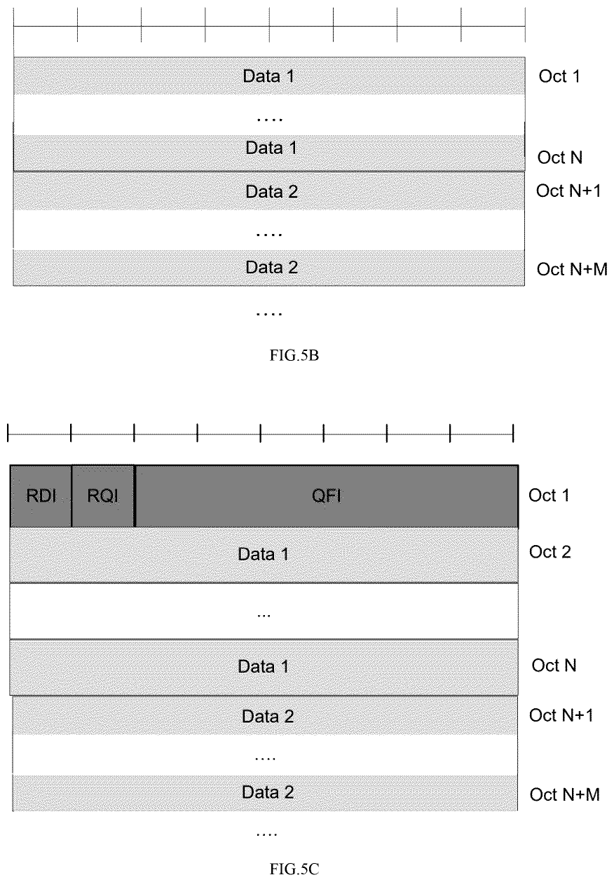

FIG. 5A shows a mapping between a PDU set and an SDAP PDU, in which the PDUs in a GTP-U, NG-U, Xn-U, or NAS-U PDU set are included in one SDAP PDU.

In some embodiments, one SDAP SDU (service data unit) (e.g. A GTP-U PDU, NG-U PDU, Xn-U PDU or NAS-U PDU) is included in an SDAP PDU from the first bit onward.

In one embodiment, by concatenation of the packets, all the PDUs in one PDU set are included in one SDAP PDU. E.g., the PDUs in PDU Set 1 is included in one SDAP PDU, the PDUs in PDU Set 2 are included in another SDAP PDU, and so on.

FIG. 5B shows a SDAP Data PDU format without the SDAP header and with multiple upper layer PDUs. FIG. 5C shows a DL SDAP Data PDU format with the SDAP header. FIG. 5D shows a UL SDAP Data PDU format with the SDAP header and multiple upper layer Data PDUs.

As illustrated in FIGS. 5B, 5C and 5D, SDAP PDUs including multiple upper layer data PDUs in one PDU set, in which the PDUs in one PDU set or QoS flow (e.g. a GTP-U, NG-U, Xn-U, or NAS-U PDU) are included in one SDAP PDU. The PDUs are concatenated one by one based on PDU sequence numbers and included in the data field of the SDAP PDU from the first bit onward.

### Embodiment 3 (PDUs in One PDU Set are Mapped to One PDCP PDU)

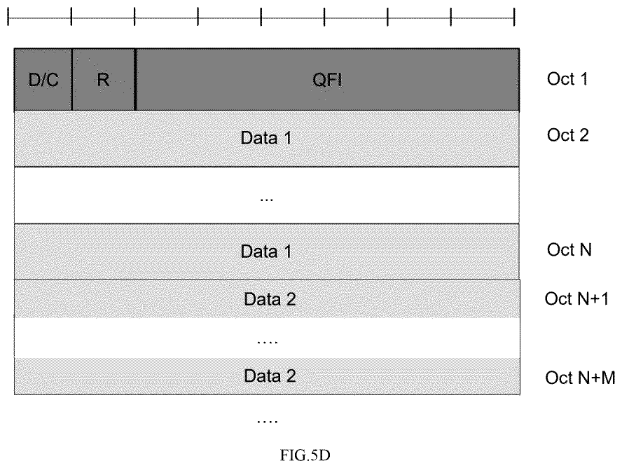

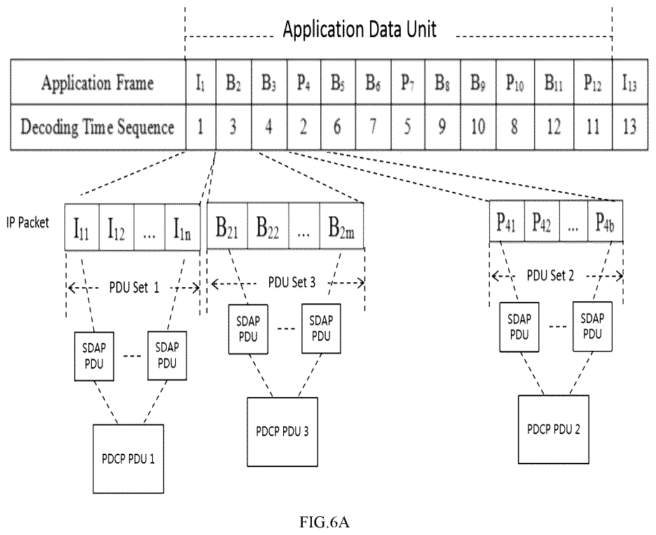

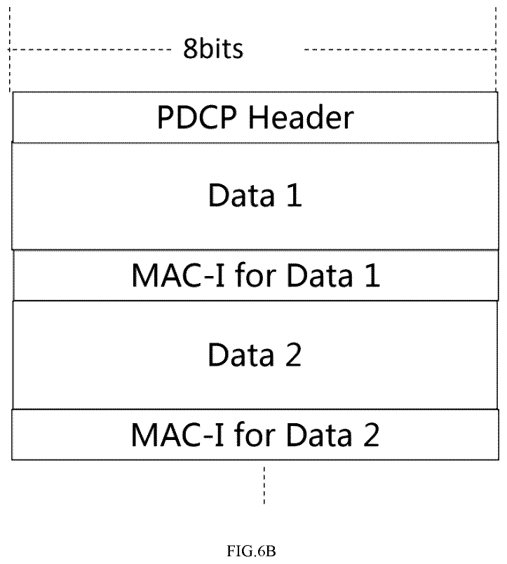

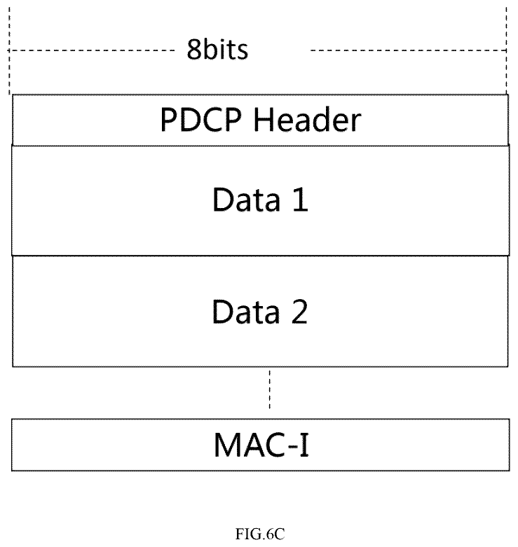

FIG. 6A shows a mapping between PDU sets and PDCP PDUs, in which the PDUs in one GTP-U, NG-U, Xn-U, or NAS-U PDU set are mapped into one PDCP PDU. More specifically, PDUs in one PDU set (e.g. a GTP-U, NG-U, Xn-U, or NAS-U PDU set) are included in one or more SDAP PDUs, and all the SDAP PDUs corresponding to one PDU set (e.g. a GTP-U, NG-U, Xn-U, or NAS-U PDU set) are included in one PDCP PDU.

FIGS. 6B and 6C show PDCP PDUs including multiple PDCP SDUs (e.g., SDAP PDUs), in which multiple PDCP data fields with corresponding MAC-I fields are included and concatenated in sequence as shown in FIG. 6B, or multiple PDCP data fields are concatenated in sequence with one corresponding MAC-I field (see FIG. 6C).

One PDCP data field (e.g., Data 1 or Data 2 in FIGS. 6B and 6C) corresponds to one PDCP SDU (e.g. SDAP PDU).

### Embodiment 4 (PDU Set Indications in SDAP, PDCP and RLC PDUs)

In this embodiment, the PDUs in one PDU set are included in multiple PDCP PDUs, and the PDU set information is included in SDAP PDU, PDCP PDU and/or RLC PDU to indicate which PDUs belong to one PDU set.

Based on the PDU set sequence numbers and/or PDU set information in the embodiments corresponding to FIG. 3 or FIG. 4, the SDAP entity can identify the PDU Set start and end occasions. However, the DL grant is scheduled in the MAC layer, and whether the PDUs in one PDU set are transmitted in one TB (transport block), in one TB group or in the same time domain position is decided in the RLC layer and/or the MAC layer. Thus, the RLC layer and/or the MAC layer also needs information of the PDU Set start and end occasions.

In some embodiments, all TBs for one RLC PDU are received successfully before concatenation. The RX (receiving) side RLC entity can know whether all TBs for one RLC PDU are received successfully according to the SN (sequence number) and SI (system information) fields and/or SN, SI and SO (segment offset) fields. The SI and SO fields are for the same RLC SDU (e.g., the same PDCP PDU).

For the PDU Set with multiple PDCP PDUs, there are some possible solutions to indicate to RLC and/or MAC layers that the RLC SDUs belong to the same PDU set.

Option 1: SDAP PDU Set fields, PDCP PDU Set fields, and/or RLC PDU Set fields including information for PDU Set identification are included in SDAP, PDCP, and/or RLC PDU format as a temporary header fields, which are maintained in the TX (transmission) side and may not be transmitted over the Uu interface.

Option 2: SDAP PDU Set fields, PDCP PDU Set fields, and/or RLC PDU Set fields including information for PDU Set identification are introduced in SDAP, PDCP, and/or RLC PDU format, e.g. using reserved bits of the existing PDU format, which are transmitted over the Uu interface without increasing Uu overhead, or using new PDU format, which are transmitted over the Uu interface.

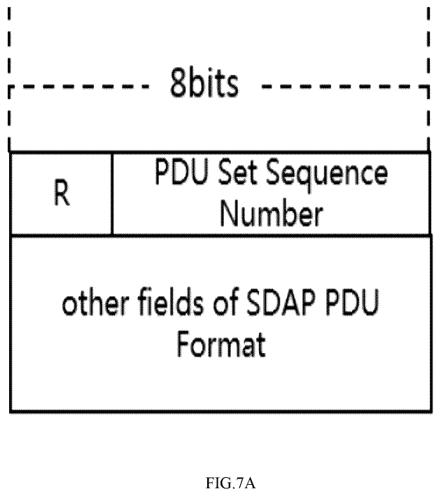

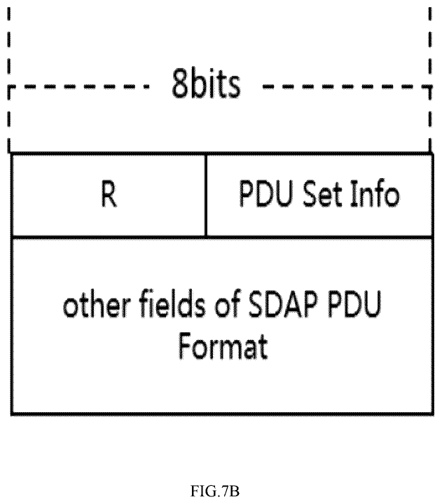

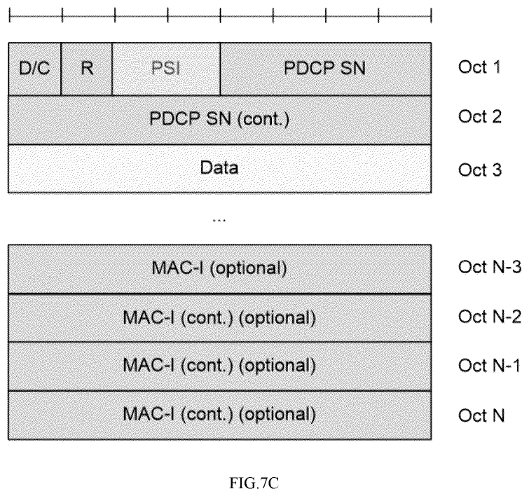

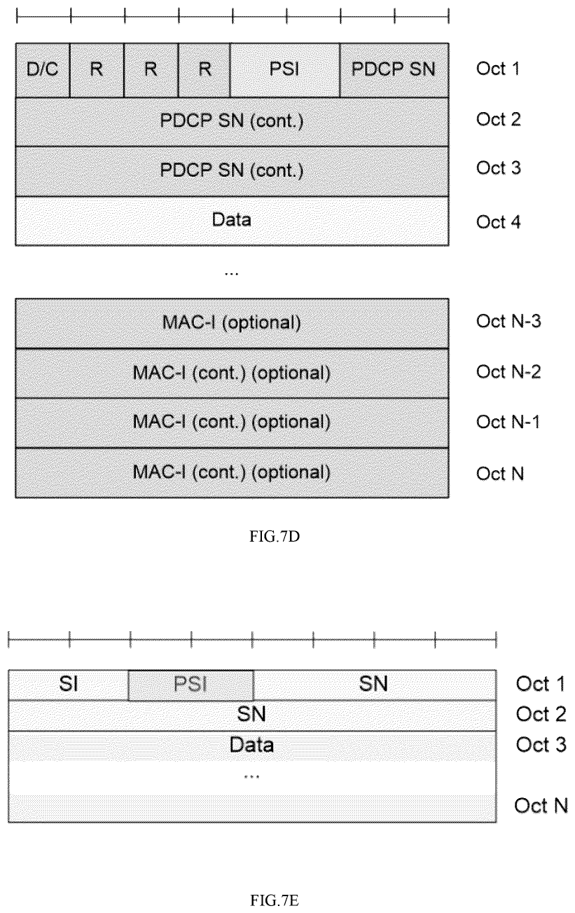

FIG. 7A shows that the SDAP PDU includes a PDU set sequence number. In this embodiment, the PDU set sequence number is used to indicate the corresponding PDU belong to which PDU set. E.g., the PDUs with the same PDU set sequence number belong to the same PDU set.

FIG. 7B shows that the SDAP PDU includes PDU set information. In this embodiment, the PDU set information is used to indicate which PDUs belong to one PDU set. E.g., the PDU set start indication and/or the PDU set end indication may be included in the SDAP PDU. A sequence of PDUs starting from the first PDU with a PDU set start indication to the last PDU with a PDU set end indication belong to one PDU set.

FIG. 7C shows that PDU set Information (PSI) is included in a PDCP Data PDU with 12 bits PDCP SN. FIG. 7D shows that PDU set Information (PSI) is included in a PDCP Data PDU for DRBs (data radio bearers) with 18 bits PDCP SN.

As illustrated in FIG. 7C and FIG. 7D, the PDU set information is indicated in the PDCP PDU. In embodiments corresponding to FIG. 7C and FIG. 7D, the PDU set Information (PI or PSI) field is included in the PDCP PDU to indicate which PDCP PDUs correspond to a PDU set and transmitted in one TB, in one TB group or in the same time domain position.

FIG. 7E shows that PDU set information (PSI) is included in a UMD (unacknowledged mode data) RLC PDU with 12 bits SN (without SO). FIG. 7F shows that PDU set information (PSI) is included in a UMD (unacknowledged mode data) RLC PDU with 12 bits SN (with SO). FIG. 7G shows that PDU set information (PSI) is included in an AMD (acknowledged mode data) RLC PDU with 18 bits SN (without SO). FIG. 7H shows that PDU set information (PSI) is included in an AMD (acknowledged mode data) RLC PDU with 18 bits SN (with SO).

As illustrated in FIGS. 7C, 7D, 7E, 7F, 7G and 7H, the PDU set information is indicated in the PDCP PDU and/or RLC PDU.

In some embodiments, the PDU set information (PI or PSI) field is included in the PDCP PDU to indicate which RLC PDUs correspond to a PDU set and transmitted in one TB, in one TB group or in the same time domain position.

An UMD PDU header contains the SN field only when the corresponding RLC SDU is segmented or when PDU set information is included in the UMD PDU. If PDU set information is included in the PDU, the SNs in the PDUs are encoded/numbered among a PDU set (e.g., across multiple SDUs).

In some embodiments, the PDU set information (PI or PSI) field can be encoded as the followings:

In some embodiments, a PI field may be used. In some embodiments, the PI field may have a length of 2 bits. In some embodiments, the PI fields are used to indicate whether some PDUs correspond to an identical PDU set. E.g., the PI field may indicate that a PDU is at the beginning, middle and/or at the end of the PUD set, or PDU set information is not included. Specifically, the PI field indicates whether PDU set information is not included, whether the PDU corresponds to the first PDU of a PDU set, whether the PDU corresponds to the last PDU of a PDU set, whether the PDU corresponds to neither the first PDU nor the last PDU of a PDU set. The interpretation of the PI field is provided in Table 1.

TABLE 1
PI field interpretation

| Value | Description |
|---|---|
| 00 | The PDU corresponds to the first PDU of the PDU set, and the |
| | PDU corresponds to the last PDU of the PDU set. E.g., the PDU |
| | set has only one PDU or PDU set information is not included. |
| 01 | The PDU corresponds to the first PDU of the PDU set, and the |
| | PDU does not corresponds to the last PDU of the PDU set. E.g., |
| | the PDU set begins from this PDU. |
| 10 | The PDU corresponds to the last PDU of the PDU set, and the |
| | PDU does not corresponds to the fist PDU of the PDU set. E.g., |
| | the PDU set ends at this PDU. |
| 11 | The PDU corresponds neither to the last PDU of the PDU set, nor |
| | to the first PDU of the PDU set. E.g., this PDU is in middle of |
| | the PDU set. |

Alternatively, a PSI field may be used. In some embodiments, the PSI field may have a length of 2 bits. In some embodiments, the PSI field indicates whether a PDU set contains a single SDU, or a corresponding PDU is the first PDU, the last PDU, or a middle PDU (neither the first nor the last PDU) of the PDU set, or PDU set information is not included. The interpretation of the PSI field is provided in Table 2.

TABLE 2
PSI field interpretation

| Value | Description |
|---|---|
| 00 | PDU set contains a single PDU or PDU set information is not |
| | included. |
| 01 | The PDU is the first PDU of a PDU set. |
| 10 | The PDU is the last PDU of a PDU set. |
| 11 | The PDU is the neither the first PDU nor the last PDU of a PDU |
| | set. |

Note that the mapping between the values and the descriptions may be changed. For example, the value “01” can be used to indicate that the PDU is the last PDU of a PDU set, and the value “10” can be used to indicate that the PDU is the first PDU of a PDU set.

In some embodiments, when the segmentation is not supported in PDCP, one PDCP PDU corresponds to one PDCP SDU. The PI (or PSI) of a PDCP PDU can be configured based on the PDU set information of PDCP SDU (e.g., DL PDU SESSION INFORMATION (PDU Type 0) Format enhancement or SDAP PDU). For example, the first PDCP SDU of the PDU set from the higher layer is set as the first PDCP PDU, and the last PDCP SDU of the PDU set from the higher layer is set as the last PDCP PDU.

In some embodiments, since an RLC SDU maybe segmented into multiple RLC PDUs and the multiple RLC PDUs correspond to the same SN number with different SIs and/or SOs, the PI (or PSI) for the RLC PDU can be set with the following options:

Option 1: set the PI (or PSI) based on the SN. E.g., multiple RLC PDUs with same RLC SDU SN (e.g. PDCP PDU SN) are configured with the same the PI (or PSI) value.

Option 2: set the PI (or PSI) based on the RLC PDU. E.g., only one RLC PDU is set as the first PDU in the PDU set and only one RLC PDU is set as the last PDU in the PDU set. That is, the PI (or PSI) for the first PDU (with SI=01) of the first RLC SDU is set as the first PDU in the PDU set (e.g., with a value “01”), and the PI (or PSI) for the last PDU (with SI=10) of the last RLC SDU is set as the last PDU in the PDU set (e.g., with a value “10”).

In some embodiments, when the segmentation is supported in PDCP, the same rules for setting the PI (or PSI) fields of RLC PDUs can be applied to PDCP PDUs.

Based on the PI (or PSI) fields and SNs, the lower layer can know which PDUs corresponds one PDCP PDU Set. E.g., the lower layer can know the start SN and the end SN of the PDU set.

In some embodiments, the PDU Set information (e.g. PI or PSI) of the RLC PDU and/or PDCP PDU may only be used for the TX side scheduling, and not for the RX side reception and decoding. The PDU Set information (e.g. PI or PSI) can be set in a temporary header field of PDCP PDU and/or RLC PDU, e.g. the temporary header fields appends to the PDCP PDU and/or RLC PDU. In such a case, when a lower layer entity receives the PDCP PDU and/or RLC PDU with the temporary header field, the lower layer may remove the temporary header field after retrieval of the PDU Set information. Accordingly, the temporary header field may not be transmitted over Uu interface (e.g., may not be transmitted from a gNB (gNodeB) to a UE (user equipment), or from a UE to a gNB).

### Embodiment 5 (PDU Set Dependency Indication)

In some embodiments, the PDU sets may depend on each other (e.g., in video streaming service, the B-frame depends on its previous adjacent frame; and the P-frame depends on its previous adjacent frame and successive adjacent frame), and different PDU sets may have different priorities (e.g., importance levels). In some embodiments, various options are provided to identify the dependency and the priorities as below.

Option 1: Different PDU sets with different priorities are mapped to one DRB, and a PDU set type indication (e.g. the PDU set corresponds to I-Frame, corresponds to B-Frame, or corresponds to P-Frame, primary frame, secondary frame, nth secondary frame, where n is a integer) or a PDU set dependency indication (e.g. the PDU set is individual, depends on a PDU set immediately ahead, depends on a PDU set immediately ahead and a PDU set immediately afterwards) are indicated in the SDAP PDU, PDCP PDU and/or RLC PDU.

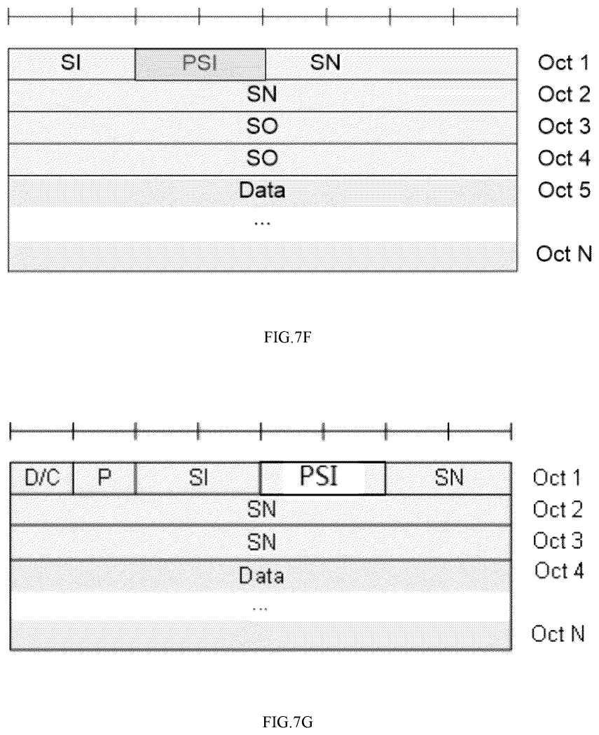

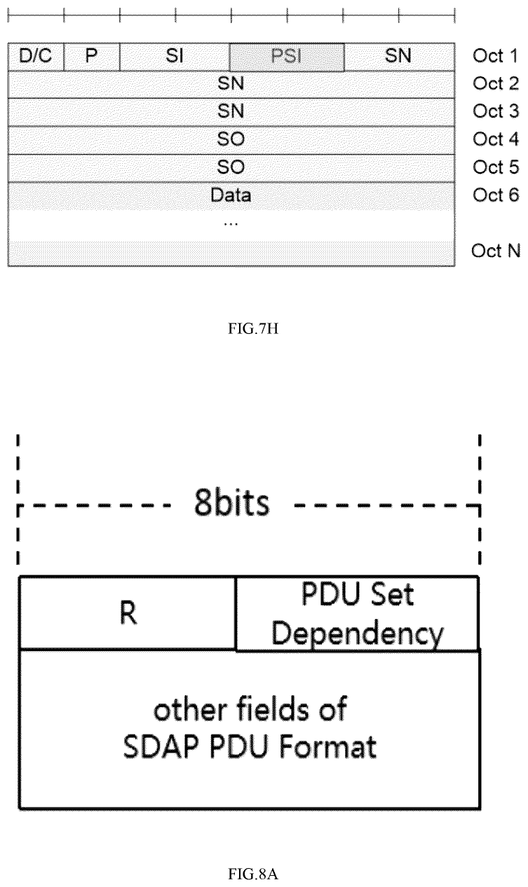

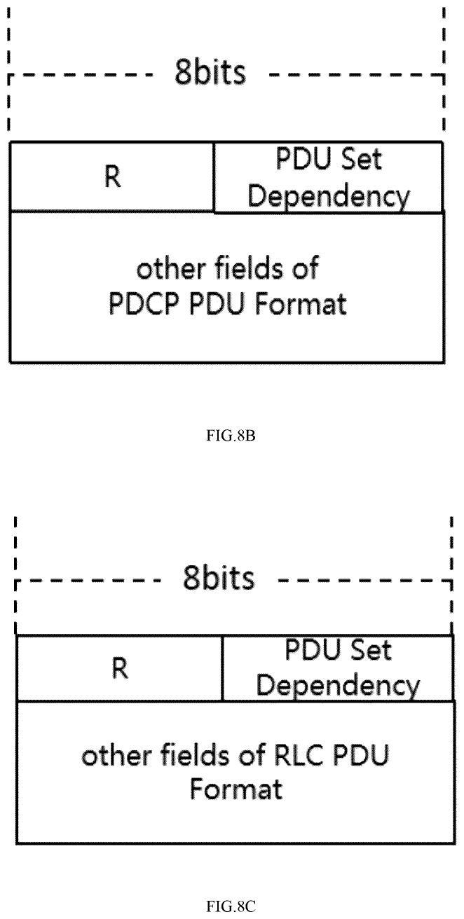

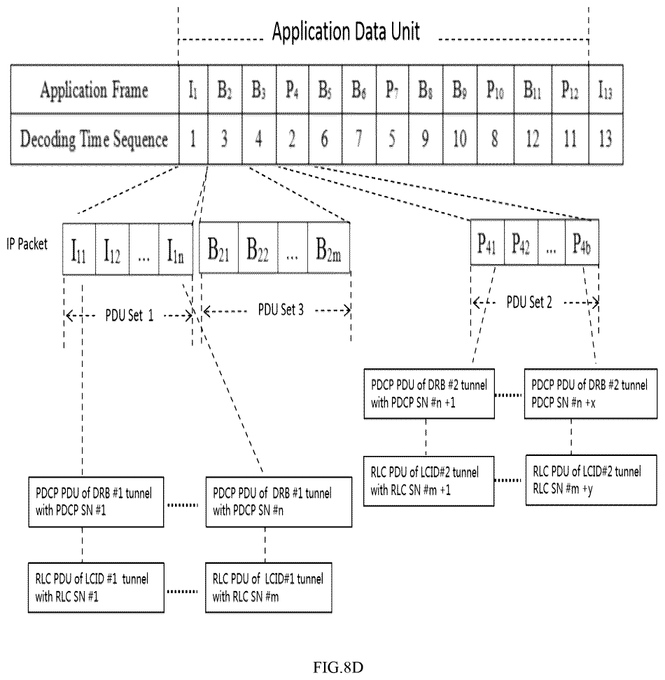

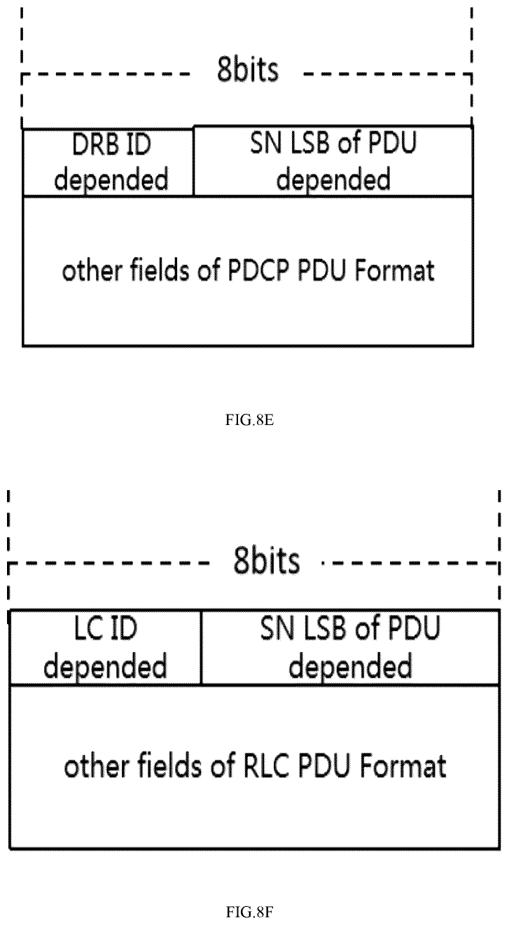

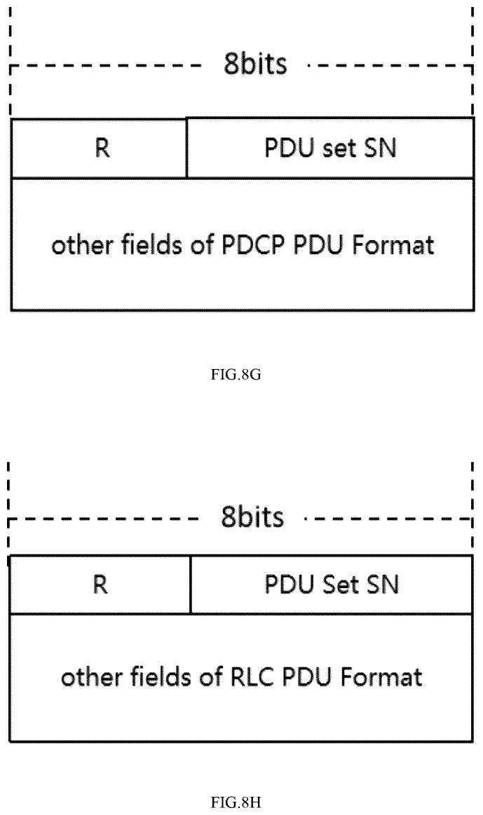

FIG. 8A shows that a PDU set dependency indication is included in a SDAP PDU. FIG. 8B shows that a PDU set dependency indication is included in a PDCP PDU. FIG. 8C shows that a PDU set dependency indication is included in an RLC PDU. Whether the new SDAP PDU format, PDCP PDU format and/or RLC PDU format being used may be indicated explicitly by UE specific signaling.

Option 2: Different PDU sets with different priorities are mapped to different QoS flows and are mapped to different DRBs and/or different Logical channels. The PDU set dependency relationship between PDU sets is implicitly indicated by SNs in the PDUs. E.g. the SNs in PDCP PDUs are encoded/numbered over multiple DRBs and/or over multiple Logical channels when PDU set information is included in the PDCP PDUs. The SNs in RLC PDUs are encoded/numbered over multiple DRBs and/or over multiple Logical channels when PDU set information is included in the RLC PDUs.

FIG. 8D shows that the SNs in PDCP PDUs and RLC PDUs are encoded/numbered over multiple DRBs and/or over multiple Logical channels when the PDU set information is included.

In some embodiments, the PDCP PDUs in PDU set 1 are mapped to DRB #1 tunnel, and the PDCP PDUs in PDU set 2 are mapped to DRB #2 tunnel.

In some embodiments, the RLC PDUs in PDU set 1 are mapped to LC #1, the RLC PDUs in PDU set 2 are mapped to LC #2. LC refers to logical channel.

In some embodiments, the sequence numbers of PDCP PDUs in PDU set 1 are encoded/numbered from 1 to n, the sequence numbers of PDCP PDUs in subsequent PDU set (e.g., PDU Set 2) are encoded/numbered from n+1 to n+x, and so on.

In some embodiments, the sequence number of RLC PDUs in PDU set 1 are encoded from 1 to m, the The sequence number of RLC PDUs in subsequent PDU set (e.g., PDU Set 2) are encoded from m+1 to m+y, and so on.

Option 3: The dependency relationship/information is indicated explicitly. E.g., Associated Sequence Numbers, an Associated DRB IDs (identifiers), and/or logical channel IDs are included in PDCP PDUs and/or RLC PDUs.

FIG. 8E shows that the PDU dependency information is included in a PDCP PDU, and FIG. 8F shows that the PDU dependency information is included in an RLC PDU.

In some embodiments, the PDU dependency information is explicitly indicated in the PDU. In some embodiments, the PDU dependency information includes as least of the: a DRB ID depended (e.g., indicating the DRB the corresponding PDU depends on), an LC ID depended (e.g., indicating the LC the corresponding PDU depends on), an SN of PDU depended (e.g., indicating the SN of the PDU the corresponding PDU depends on) and/or an SN LSBs (Least Significant Bit) of PDU depended (e.g., indicating the LSBs in the SN of PDU the corresponding PDU depends on, SN LSBs is used instead of the SN to reduce the bit requirement).

In some embodiments, whether the new PDCP PDU format and/or RLC PDU format being used may be explicitly indicated by UE specific signaling.

In some embodiments, since the Associated Sequence Number (e.g., the “SN of PDU depended” as described above) and Associated DRB ID (e.g., the “DRB ID depended” as described above) or LC ID (e.g., the “LC ID depended” as described above) are only used in the TX scheduling and have lots of bits (overhead), some optimization may be applied.

Alt 1: only the LSB of SN is used as the Associated Sequence Number.

Alt 2: the Associated Sequence Number, the Associated DRB ID, and/or the logical channel ID is designed as a temporary header field of the PDCP PDU and/or the RLC PDU, and the temporary header field appends to the PDCP PDU and/or RLC PDU. When the lower layer receives the PDCP PDU and/or RLC PDU and obtain the temporary header field information, the lower layer may remove the temporary header field. Accordingly, the temporary header field may not be transmitted over Uu interface (e.g. does not be transmitted from the gNB to the UE, or from the UE to the gNB).

Option 4: PDU set sequence numbers are included in the PDCP PDUs and/or RLC PDUs, and the PDU set sequence numbers are encoded/numbered over multiple DRBs and/or multiple logical channels based on the PDU set sequence numbers in the PDCP SDUs. The PDU set in the PDCP PDU or RLC PDU may correspond to the same user data contained in the PDU set in the GTP-U, NG-U, Xn-U, or NAS-U PDU set and QoS flows, regardless the PDU set is segmented or not, and regardless the PDU set is converged or not.

FIG. 8G shows that a PDU set SN (sequence number) is included in a PDCP PDU, and FIG. 8H shows that a PDU set SN is included in an RLC PDU.

In some embodiments, whether the new PDCP PDU format and/or RLC PDU format being used may be explicitly indicated by UE specific signaling.

The PDU set SNs are encoded/numbered over multiple DRBs and/or multiple logical channels if PDU set information is included in the corresponding PDU.

Based on the PDU set SN and/or the PDU SN, the PDU set time sequence can be identified.

### Embodiment 6 (Reflective QoS Indication)

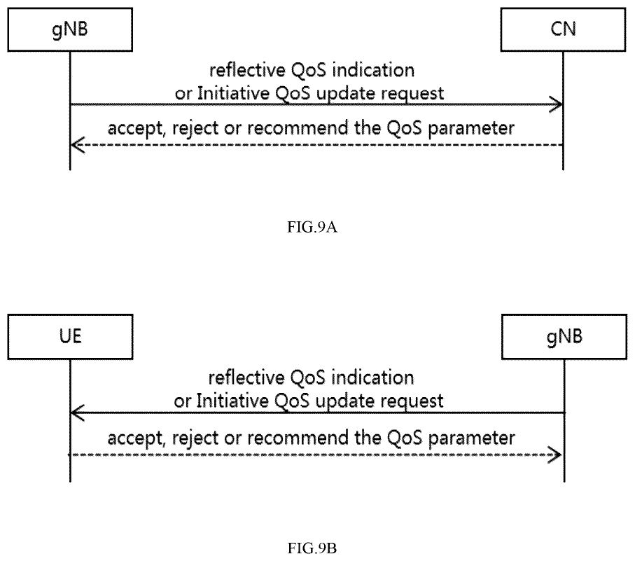

FIG. 9A shows a procedure relevant to a reflective QoS indication or an initiative QoS update request.

In some embodiments, based on the NW (network) capability and/or NW preference, the reflective QoS indication or initiative QoS update request is sent from the gNB to the CN to trigger a QoS parameters update. E.g., the RAN (Radio Access Network) provides QoS Assistance information to the CN or the Application layer to request dynamically adjusting the QoS parameters.

In some embodiments, the QoS Assistance information includes at least one of the parameter type: a suggested QoS parameter value, a suggested priority level of QoS flow, suggested application data and a QoS flow mapping, a suggested paging strategy, UE mobility information, Artificial intelligence related information, machine learning related information, network usage awareness, network Computational capability, and/or UE positioning related information.

In some embodiments, the gNB can provide one or more sets of suggested QoS Assistance information, and the CN can determine, select, accept, reject, or recommend the QoS information based on the one or more set of suggested QoS Assistance information.

In some embodiments, the QoS Assistance information includes at least one of the following parameters:
a maximal aggregated bit rate per cell carried over Cell specific signaling that the gNB prefers or allows;
a maximal bit rate per QoS flow carried, which is carried over UE specific signaling or an NG-U PDU that the gNB prefers or allows;
a maximal aggregated bit rate per PDU session, which is carried over UE specific signaling or an NG-U PDU that the gNB prefers or allows;
a DL PDU transmission time offset, which is carried over UE specific signaling or an NG-U PDU, which is used to indicate the CN to transmit PDUs of the QoS flow and/or the PDU session with a time delay offset (e.g., corresponding to the DL PDU transmission time offset) or a time advance offset (e.g., corresponding to the DL PDU transmission time offset). The DL PDU transmission time offset is relative to at least one of the current transmission start time, the current transmission end time, and/or the current transmission timing occasion;
a DL PDU arriving time, which is carried over UE specific signaling or an NG-U PDU, and is used to indicate the CN to transmit PDUs of the QoS flow and/or the PDU session to ensure that the PDUs arrive at the gNB based on the indicated DL PDU arriving time;
a maximal packet size that the gNB prefers or supports, which is carried over UE specific signaling or an NG-U PDU, and is used to ensure that the packet size received can is suitable for gNB;
an application coding data rate that the gNB prefers, which is carried over UE specific signaling or an NG-U PDU, and is used to dynamically adjust the application coding data rate;
a CN PDB (Packet Delay Budget) that the gNB detects, which is carried over UE specific signaling or an NG-U PDU, and is used for the gNB to decide the DL data transmission occasion;
PDB headroom that the gNB detects, which is used for the gNB to decide the DL data transmission occasion;
a BER that the gNB detects;
a PER, that the gNB detects;
a network node load information;
a network node self Computational capability headroom;
a Computational capability headroom request to core network or cloud native;
a Uu Time Synchronization Error Budget;
a Uu Packet Delay Budget;
a Uu Packet Delay Budget headroom;
a time duration that the service is preferred to be used, which is carried over UE specific signaling or an NG-U PDU, and is used for the gNB to decide the DL data transmission occasion;
and/or
a start time that the service is preferred to be triggered, which is carried over UE specific signaling or an NG-U PDU, and is used for the gNB to decide the DL data transmission occasion.

The QoS Assistance information can be used to trigger the DL user data rate adaption (e.g., the application coding data rate adjustment, from HD (high definition) video to SD (standard definition) video or from SD video to HD video), to map the traffic pattern with the network resource, and/or to adjust the QoS parameters and improve the user experience.

FIG. 9B shows another procedure relevant to a reflective QoS indication or an initiative QoS update request.

In some embodiments, based on the NW (network) capability and/or NW preference, the reflective QoS indication or initiative QoS update request is sent from the gNB to the UE to trigger a QoS parameters update. E.g., the RAN (Radio Access Network) provides QoS Assistance information to the UE to request dynamically adjusting the QoS parameters.

In some embodiments, the QoS Assistance information includes at least one of the parameter type: a suggested QoS parameter value, a suggested priority level of QoS flow, suggested application data and a QoS flow mapping, a suggested paging strategy, UE mobility information, Artificial intelligence related information, machine learning related information, network usage awareness, network Computational capability, and/or UE positioning related information.

In some embodiments, the gNB can provide one or more sets of suggested QoS Assistance information, and the UE can determine, select, accept, reject, or recommend the QoS information based on the one or more set of suggested QoS Assistance information.

In some embodiments, the QoS Assistance information includes at least one of the following parameters:
a maximal aggregated bit rate per UE that the gNB prefers or allows;
a maximal aggregated bit rate per DRB that the gNB prefers or allows;
a maximal aggregated bit rate per logical channel that the gNB prefers or allows;
a maximal aggregated bit rate per logical channel group that the gNB prefers or allows;
an application coding data rate that the gNB prefers, which is used to dynamically adjust the application coding data rate;
a UL PDU transmission time offset, which is used to indicate the UE to transmit PDUs of the DRB and/or the Logical channel with a time delay offset (e.g., corresponding to the UL PDU transmission time offset) or a time advance offset (e.g., corresponding to the UL PDU transmission time offset). The UL PDU transmission time offset is relative to at least one of the current transmission start time, the current transmission end time, and/or the current transmission timing occasion;
a UL PDU transmitting time, which is used to indicate the UE to transmit PDUs of the DRB and/or the Logical channel to ensure that the PDUs transmits based on the indicated transmitting time;
a BER that the gNB detects, which is used for UE to adjust the coding rate and/or transmitting power;
   a PER that the gNB detects, which is used for UE to adjust the coding rate and/or transmitting power;
   a network node load information;
   a network node self Computational capability headroom;
   a Computational capability headroom request to core network or cloud native;
   a Uu Time Synchronization Error Budget;
   a Uu Packet Delay Budget;
   a Uu Packet Delay Budget headroom;
   a time duration that the service is preferred to be used, which is used for UE to decide the UL data transmission occasion; and/or
   a start time that the service is preferred to be triggered, which is used for UE to decide the UL service start time or data transmission occasion.

In some embodiments, the QoS Assistance information is carried over at least one of RRC (Radio Resource Control) unicast signaling, MAC CE (control element), or PDCCH (physical downlink control channel) DCI (Downlink Control Information).

In some embodiments, the QoS Assistance information can be used to trigger the UL user data rate adaption (e.g. the application coding data rate adjustment, from HD video to SD video or from SD video to HD video), map the traffic pattern with network resource, and/or improve the user experience.

### Embodiment 7 (Particular Buffer Size Indication)

For full buffer service or XR service with fixed Buffer Size, the UE may indicate the UL Buffer Size to the gNB by one of the following:
a particular BSR format (e.g., only LCG (logical channel group) ID, LC ID, or DRB ID is included in the MAC CE format with a new LC ID for MAC CE identification) is used to indicate the buffer size is the same as the latest BS reported;
only a BSR MAC Header with a new LC ID (e.g. zero BYTE MAC CE) is used to indicate that the Buffer Size is the same as the latest Buffer Size reported for the logical channel, logical channel group or DRB; or
only a BSR MAC Header with a new LC ID (e.g. zero BYTE MAC CE) is used to indicate that the Buffer Size is the same as the latest Transport Block size transmitted for the logical channel, logical channel group or DRB.

Uplink Control Information (UCI) is used to indicate that the Buffer Size is the same as the latest Buffer Size reported or Transport Block size transmitted for the logical channel, logical channel group or DRB.

With such a configuration, the BSR MAC CE radio resource consumption can be reduced.

### Embodiment 8 (Multiple C-DRX (Discontinuous Reception in RRC_Connected State) Configuration)

In some embodiments, multiple C-DRX (DRX in RRC_Connected state) may be configured per cell group, per DRB, per logical channel to deal with the non-integer periodicity issue, and/or to match the traffic pattern issue. E.g., in an XR service, fps (frame per second) or Hz (hertz) may be used as the unit to indicate the service transmission frequency. However, the unit for C-DRX periodicity is ms (millisecond), and fps or Hz may not be mapped to ms perfectly. E.g., 60 fps or 60 Hz can be converted as a period of 16.6666 . . . ms, which is not an integer and the traffic pattern cannot be mapped to a C-DRX configuration perfectly. In such a case, multiple C-DRX patterns can be used for mapping the traffic pattern. E.g., the following three C-DRX configurations can be used for mapping the traffic pattern with 60 fps or 60 Hz.

| | C-DRX start time | Periodicity |
|---|---|---|
| C-DRX 1 | startFrame = 0, startSubFrame = 0 | 50 ms |
| C-DRX 2 | startFrame = 1; startSubFrame = 7 | 50 ms |
| C-DRX 3 | startFrame = 3; startSubFrame = 4 | 50 ms |

When multiple C-DRX patterns are configured per cell group, per DRB, per logical channel, a C-DRX index or C-DRX identity is used to identify each C-DRX configuration.

In some embodiments, the C-DRX index or C-DRX identity can be explicitly configured in the C-DRX configuration.

In some embodiments, the C-DRX index or C-DRX identity can be implicitly indicated based on the C-DRX configuration SEQUENCE entries. E.g., the first entry of the SEQUENCE corresponds to the first C-DRX configuration and the C-DRX index (or C-DRX identity) equals to 1, the second entry of the SEQUENCE corresponds to the second C-DRX configuration and the C-DRX index (or C-DRX identity) equals to 2, and so on.

In some embodiments, based on the C-DRX index or C-DRX identity, one or more of the C-DRX configurations can be modified, removed activated or deactivated independently with a delta configuration. E.g., when removing a certain C-DRX configuration, only the C-DRX index or C-DRX identity corresponding to the certain C-DRX configuration may to be indicated to UE. In this case, it can avoid to indicate all the new C-DRX configurations to UE to overwrite the old C-DRX configurations.

### Embodiment 9 (PDU Relationship Indication Between UL and DL, or Between UEs)

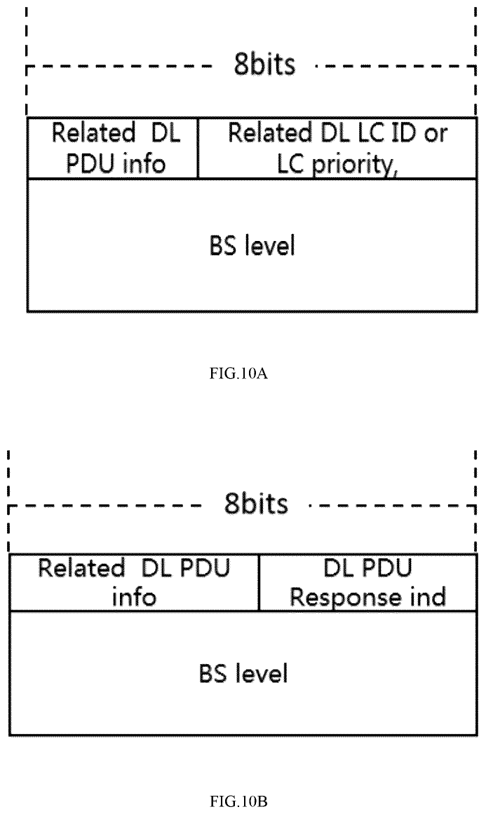

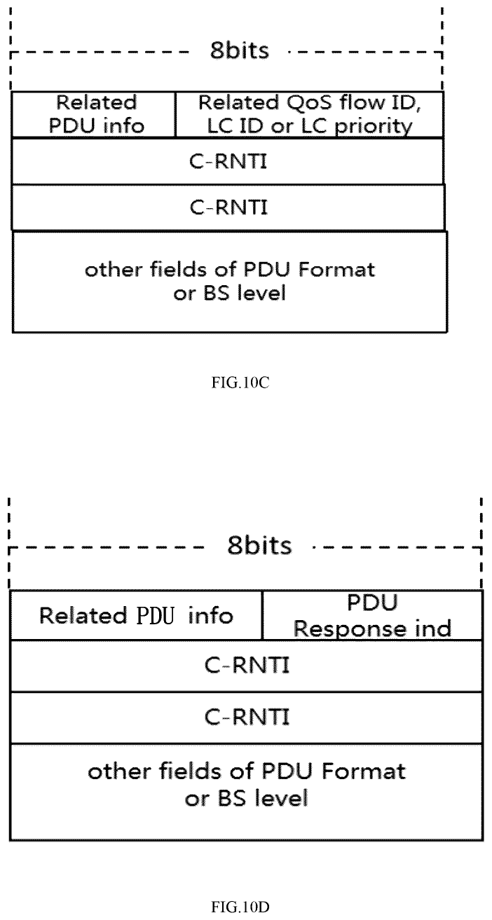

FIG. 10A shows a buffer size report. FIG. 10B shows a buffer size report with DL PDU response information.

As illustrated in FIG. 10A and FIG. 10B, the relationship indication between the UL PDU triggering BSR and the DL PDU is shown.

Upon reception the DL PDU, the UE may trigger a BSR MAC CE for transmitting the UL response PDU.

In some embodiments, the BSR MAC CE includes at least one of the following information:

the DL LC ID or DL LC priority related to the UL PDU triggering the BSR, as shown in FIG. 10A;
the DL PDU response indication related to the UL PDU triggering the BSR, as shown in FIG. 10B; and/or
the related DL PDU information, as shown in FIG. 10A and FIG. 10B, which includes at least one of the PDU SN or the PDU time domain information (e.g., SFN (System Frame Number) information, Slot information, and/or Symbol information).

FIG. 10C shows a PDU or a BSR including UE ID information and PDU information. FIG. 10D shows a PDU or a BSR including UE ID information and PDU response information

As illustrated in FIG. 10C and FIG. 10D, the relationship indication between the UEs is shown.

In some embodiments, the PDU or BSR includes at least one of the following:
the related UE ID (e.g., C-RNTI), as shown in FIG. 10C and FIG. 10D;
the related PDU information, as shown in FIG. 10C and FIG. 10D, which includes at least one of the PDU SN or the PDU time domain information (e.g., SFN information, Slot information, and/or Symbol information);
the QoS flow ID, LC ID or LC priority related to the PDU (e.g., the current PDU); and/or
the PDU response indication related to the current PDU.

In some embodiments, the current PDU includes as least one of the: a GTP-U PDU, an NG-U PDU, an Xn-U PDU, an NAS-U PDU, a SDAP PDU, a PDCP PDU, and/or an RLC PDU.

In some embodiments, based the relationship indication as described above, the gNB can decide the resource scheduling priority, or the UL grant for uplink SR (scheduling request), UL BSR and/or PUSCH transmission.

FIG. 11 relates to a schematic diagram of a wireless communication terminal 30 (e.g., a terminal node or a terminal device) according to some embodiments of the present disclosure. The wireless communication terminal 30 may be a user equipment (UE), a remote UE, a relay UE, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In some embodiments, the communication unit 320 transmits and receives the signals via at least one antenna 322.

In some embodiments, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described above. In some embodiments, the processor 300 and the communication unit 320 collaboratively perform the operations described above. For example, the processor 300 performs operations and transmit or receive signals, message, and/or information through the communication unit 320.

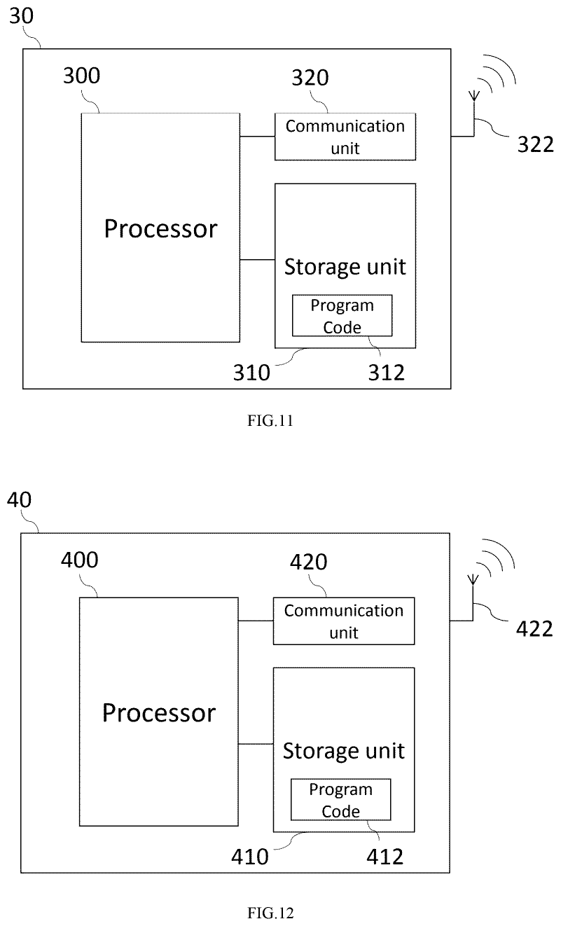

FIG. 12 relates to a schematic diagram of a wireless communication node 40 (e.g., a network device) according to some embodiments of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In some embodiments, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB described above. In some embodiments, the processor 400 and the communication unit 420 collaboratively perform the operations described above. For example, the processor 400 performs operations and transmit or receive signals through the communication unit 420.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

We claim:

1. A wireless communication method comprising:
receiving, by a wireless communication node from a higher layer, Protocol Data Units (PDUs) including identification information; and
identifying, by the wireless communication node, at least one of: PDU sets for the PDUs or a PDU set time sequence of the PDU sets;
wherein the higher layer comprises at least one of: a General Packet Radio Service Tunneling Protocol User Plane (GTP-U) a Next Generation user plane interface, NG-U, an Xn User plane, Xn-U interface, user data from Non-access stratum, NAS, or user data of Quality of Service (QOS) flow.

2. The wireless communication method of claim 1, wherein the wireless communication node receives PDU set sequence numbers for the PDU sets, and the PDU sets are determined by the PDU set sequence numbers.

3. The wireless communication method of claim 2, wherein:
the PDU set time sequence is indicated by the PDU set sequence numbers; and/or
the PDU set sequence numbers are coded across multiple QoS flows based on a decoding time sequence of the QoS flows if PDU sets are mapped to multiple QoS flows.

4. The wireless communication method of claim 1, wherein the wireless communication node receives at least one of a PDU set start indication, a PDU set end indication for each PDU set or a total PDUs number of a PDU set, and the PDU sets are determined by the at least one of the PDU set start indication, the PDU set end indication or a total PDUs number of a PDU set.

5. The wireless communication method of claim 1, wherein the PDU set time sequence is determined by QoS flow identifiers (QFIs) sequence numbers for the PDUs in the PDU sets, and the QFIs sequence numbers are coded across multiple QoS flows based on the PDU set time sequence if the PDU sets are mapped to multiple QoS flows.

6. The wireless communication method of claim 1, wherein the PDUs corresponding to each PDU set are included in a Service Data Adaption Protocol (SDAP) PDU.

7. The wireless communication method of claim 6, wherein the PDUs corresponding to each PDU set are sequentially included in the SDAP PDU based on PDU sequence numbers of the PDUs.

8. The wireless communication method of claim 1, wherein the PDUs corresponding to each PDU set in one or more SDAP PDUs, are included in a Packet Data Convergence Protocol (PDCP) PDU.

9. The wireless communication method of claim 8, wherein the PDUs corresponding to each PDU set are sequentially included in the PDCP PDU.

10. The wireless communication method of claim 8, wherein the PDCP PDU comprises one or more Message Authentication Code-Integrity (MAC-I) for the one or more SDAP PDUs.

11. The wireless communication method of claim 1, the PDU sets is indicated in at least one of an SDAP PDU, a PDCP PDU, or a radio link control (RLC) PDU, and the PDU sets is indicated by using at least one of a temporary header or reserved bits.

12. The wireless communication method of claim 11, wherein an indication of the PDU sets in the at least one of the SDAP PDU, the PDCP PDU, or the RLC PDU comprises at least one of a PDU set sequence number or a PDU set indication, and information of the PDU set indication comprises at least one of: an indication indicating that information of the PDU set is not included, an indication indicating that a corresponding PDU is in a PDU set having single PDU, an indication indicating a corresponding PDU is at a start position of a corresponding PDU set, an indication indicating a corresponding PDU is at an end position of a corresponding PDU set, or an indication indicating a corresponding PDU is at a middle position of a corresponding PDU set.

13. The wireless communication method of claim 1, wherein the SDAP PDUs, PDCP PDUS or RLC PDUs corresponding to the same PDU sets are transmitted in one transport block (TB) in one TB group or in an identical time domain position.

14. The wireless communication method of claim 1, wherein a PDU set type indication or a PDU set dependency indication is included in at least one of an SDAP PDU, a PDCP PDU, or an RLC PDU, and the information of the PDU sets is indicated by using at least one of a temporary header or reserved bits.

15. The wireless communication method of claim 14, wherein:
the PDU set type indication indicates a corresponding PDU set corresponds to a video compression type of a I-Frame, a B-Frame, or a P-Frame, or indicates a corresponding PDU set decoding time sequence or PDU set decoding dependency comprising at least one of a primary frame, a secondary frame, or a nth secondary frame, where n is integer; and/or
the PDU set dependency indication indicates a corresponding PDU set is individual, depends on a PDU set immediately ahead, or depends on a PDU set immediately ahead and a PDU set immediately afterwards.

16. The wireless communication method of claim 1, wherein a PDU set dependency relationship between PDUs is indicated by including sequence numbers, SNs, in at least one of PDCP PDUs or RLC PDUs, and the SNs in the at least one of the PDCP PDUs or the RLC PDUs are encoded over multiple data radio bearers (DRBs).

17. The wireless communication method of claim 1, wherein the wireless communication node indicates a PDU set dependency relationship of a PDU by including an SN of an associated PDU and an identifier (ID) of an associated DRB or an associated logical channel in at least one of a PDCP PDU or an RLC PDU.

18. The wireless communication method of claim 1, wherein the wireless communication node indicates PDU set sequence numbers in at least one of PDCP PDUs or RLC PDUs, and the PDU set sequence numbers are encoded over multiple DRBs or multiple logical channels based on the PDU set sequence numbers in PDCP service data units, SDUs.

19. A wireless communication node, comprising:
a communication unit; and
a processor configured to: receive, from a higher layer, Protocol Data Units (PDUs) including PDU set information; and identify at least one of PDU sets for the PDUs or a PDU set time sequence of the PDU sets; wherein the PDUs are scheduled for transmission over a Uu interface according to at least one of: the PDU sets or the PDU set time sequence: wherein the higher layer comprises at least one of: a General Packet Radio Service Tunneling Protocol User Plane (GTP-U), a Next Generation user plane interface (NG-U), an Xn User plane (Xn-U) interface, user data from Non-access stratum (NAS), or user data of Quality of Service (QOS) flow.

20. A non-transitory computer-readable storage medium having stored thereon computer program instructions, wherein the instructions, when executed by a processor, causing the processor to implement the wireless communication method of claim 1.
